(19) United States
(12) Patent Application Publication
(10) Pub. No.: US 2009/0289999 A1
(43) Pub. Date: Nov. 26, 2009

(54) LIQUID EJECTING HEAD AND LIQUID EJECTING APPARATUS INCLUDING THE SAME

(75) Inventors: Wataru TAKAHASHI, Chino-shi (JP); Toru NAGATE, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/471,184

(22) Filed: May 22, 2009

(30) Foreign Application Priority Data
May 22, 2008 (JP) 2008-133950

(51) Int. Cl. B41J 2/045

(52) U.S. Cl. 347/71

(57) ABSTRACT

A liquid ejecting head that ejects a liquid from a nozzle opening includes a first channel-forming substrate having a pressure-generating chamber that includes a diaphragm. A second channel-forming substrate is disposed on a surface opposite the diaphragm. An actuator that includes the diaphragm applies pressure to the pressure-generating chamber to eject the liquid from the nozzle opening. A first protective film is disposed on an inner surface of the pressure-generating chamber. A second protective film is disposed on a surface of the second channel-forming substrate that faces the first channel-forming substrate. The first channel-forming substrate is bonded to the second channel-forming substrate with an adhesive between the first and second protective films. Before curing, a contact angle θ1 of a surface of the first protective film to the adhesive is larger than a contact angle θ2 of a surface of the second protective film to the adhesive.

### BACKGROUND

1. Technical Field

The present invention relates to a liquid ejecting head and a liquid ejecting apparatus including the same. In particular, the invention relates to an ink jet recording head in which a part of a pressure-generating chamber communicating with a nozzle opening that ejects ink droplets is constituted by a diaphragm and which ejects ink droplets by driving an actuator including the diaphragm.

2. Related Art

A known structure of an ink jet recording head includes a channel-forming substrate including a row of pressure-generating chambers communicating with nozzle openings and a joining substrate which is bonded adjacent to piezoelectric elements, which are pressure-generating elements provided on the channel-forming substrate, and on which a driving IC for driving the piezoelectric elements is mounted. The nozzle openings are provided in a nozzle plate, and the nozzle plate is bonded to the channel-forming substrate with an adhesive or the like. According to a known method of producing a liquid ejecting head, in the case where a nozzle plate is bonded to a channel-forming substrate having pressure-generating chambers with an adhesive, a hydrophilic treatment is performed on a joining portion of the nozzle plate so that the adhesive readily flows to the joining portion, thus suppressing a flow of the adhesive to the pressure-generating chambers. When the flow of the adhesive to the pressure-generating chambers is suppressed, adhesion of the adhesive to a diaphragm constituting a part of each of the pressure-generating chambers decreases, and thus a degradation of displacement characteristics of the diaphragm can be suppressed (refer to, for example, JP-A-2007-50673 (paragraph 9 and FIG. 6).

In producing a liquid ejecting head, when an adhesive is adhered to a diaphragm, displacement characteristics of the diaphragm are degraded and varied. In addition, in using the liquid ejecting head, pressure-generating chambers, liquid channels, and a nozzle plate, all of which are exposed to an ejected liquid, are corroded by the ejected liquid. Consequently, the size of nozzle openings or the like is changed, thereby changing ejection characteristics of the liquid. Such problems lie not only in ink jet recording heads that eject ink droplets but also in other liquid ejecting heads that eject droplets of a liquid other than ink.

### SUMMARY

The invention can be realized as embodiments or application examples below.

### APPLICATION EXAMPLE 1

A liquid ejecting head that ejects a liquid from a nozzle opening includes a first channel-forming substrate including a pressure-generating chamber a part of which is constituted by a diaphragm; a second channel-forming substrate disposed on a surface opposite the diaphragm of the first channel-forming substrate; an actuator that includes the diaphragm and that applies a pressure to the pressure-generating chamber to eject the liquid from the nozzle opening; a first protective film having liquid resistance and disposed on an inner surface of the pressure-generating chamber; and a second protective film having liquid resistance and disposed on at least a surface of the second channel-forming substrate, the surface facing the first channel-forming substrate, wherein the first channel-forming substrate is bonded to the second channel-forming substrate with an adhesive provided between the first protective film and the second protective film, and a contact angle θ1 of a surface of the first protective film to the adhesive before curing is larger than a contact angle θ2 of a surface of the second protective film to the adhesive before curing. Not that either static contact angles or dynamic contact angles may be used as the contact angles. However, since the adhesive before curing flows during bonding, dynamic contact angles are more preferable.

According to this application example, the first protective film is provided on the pressure-generating chamber and the second protective film is provided on a surface of the second channel-forming substrate, the surface facing the first channel-forming substrate. Accordingly, corrosion due to the liquid can be prevented, and thus a liquid ejecting head having stable liquid-ejecting characteristics can be obtained. Furthermore, when the first channel-forming substrate is bonded to the second channel-forming substrate with the adhesive, the contact angle θ1 of the first protective film to the adhesive before curing is larger than the contact angle θ2 of the second protective film to the adhesive before curing. Accordingly, the adhesive before curing flows along the second protective film with which the adhesive has good affinity, and does not readily flow to the diaphragm side of the pressure-generating chamber. Thus, adhesion of the adhesive to the diaphragm of the pressure-generating chamber can be suppressed, and a liquid ejecting head in which a degradation and variations in displacement characteristics of the diaphragm are suppressed can be obtained.

### APPLICATION EXAMPLE 2

In the liquid ejecting head, the adhesive may be an epoxy adhesive, the first protective film may be composed of tantalum oxide, and the second protective film may be composed of silicon oxide. In this application example, a contact angle θ1 of the epoxy adhesive to tantalum oxide is larger than a contact angle θ2 of the epoxy adhesive to silicon oxide, and tantalum oxide and silicon oxide have high corrosion resistance against the liquid. In addition, since a film of tantalum oxide can be deposited at low temperatures, an effect of heat on the diaphragm and the like which have been formed on the first channel-forming substrate is small. Accordingly, the liquid-ejecting characteristics can be further stabilized, and thus a liquid ejecting head in which a degradation and variations in the displacement characteristics of the diaphragm are suppressed can be obtained.

### APPLICATION EXAMPLE 3

In the liquid ejecting head, the first channel-forming substrate and the second channel-forming substrate may be composed of silicon. In this application example, both the first channel-forming substrate and the second channel-forming substrate are composed of silicon, and thus generation of distortion and warpage due to a difference in thermal expansion can be suppressed. Furthermore, tantalum oxide and silicon oxide are a combination in which adhesiveness to silicon can be ensured.

### APPLICATION EXAMPLE 4

A liquid ejecting apparatus includes the liquid ejecting head described above.

According to this application example, a liquid ejecting apparatus that can achieve the above advantages can be obtained.

### BRIEF DESCRIPTION OF THE DRAWINGS

The invention will be described with reference to the accompanying drawings, wherein like numbers reference like elements.

FIG. 1 is a schematic view showing an example of an ink jet recording apparatus as a liquid ejecting apparatus according to a first embodiment.

FIG. 2 is an exploded partial perspective view showing an ink jet recording head.

FIG. 3A is a partial plan view of the ink jet recording head.

FIG. 3B is a cross-sectional view taken along line IIIB-IIIB in FIG. 3A.

FIG. 4 is a partial cross-sectional view of a head unit according to a second embodiment.

### DESCRIPTION OF EXEMPLARY EMBODIMENTS

Embodiments will now be described in detail with reference to the drawings.

### First Embodiment

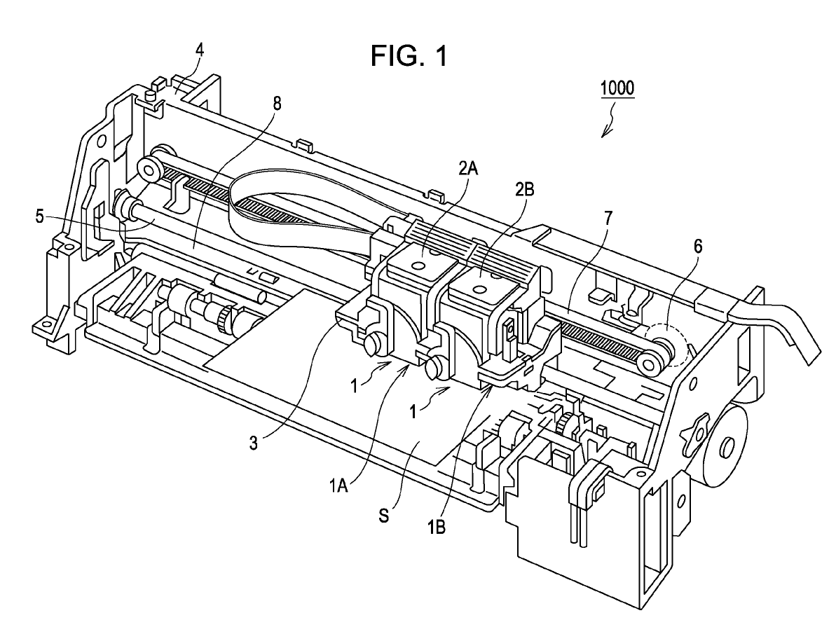

FIG. 1 is a schematic view showing an example of an ink jet recording apparatus 1000 as a liquid ejecting apparatus according to this embodiment. Referring to FIG. 1, the ink jet recording apparatus 1000 includes recording head units 1A and 1B. Cartridges 2A and 2B constituting ink supply units are detachably provided in the recording head units 1A and 1B, respectively. A carriage 3 mounting the recording head units 1A and 1B is provided on a carriage shaft 5 attached to a main body 4 so as to move in a direction of the shaft.

The recording head units 1A and 1B eject, for example, a black ink composition and a color ink composition, respectively. When a driving force of a driving motor 6 is transmitted to the carriage 3 via a plurality of gears (not shown) and a timing belt 7, the carriage 3 mounting the recording head units 1A and 1B is moved along the carriage shaft 5. A platen 8 is provided along the carriage shaft 5 in the main body 4. A recording sheet S, such as paper, used as a recording medium and fed by a paper-feeding roller (not shown) or the like is transported on the platen 8.

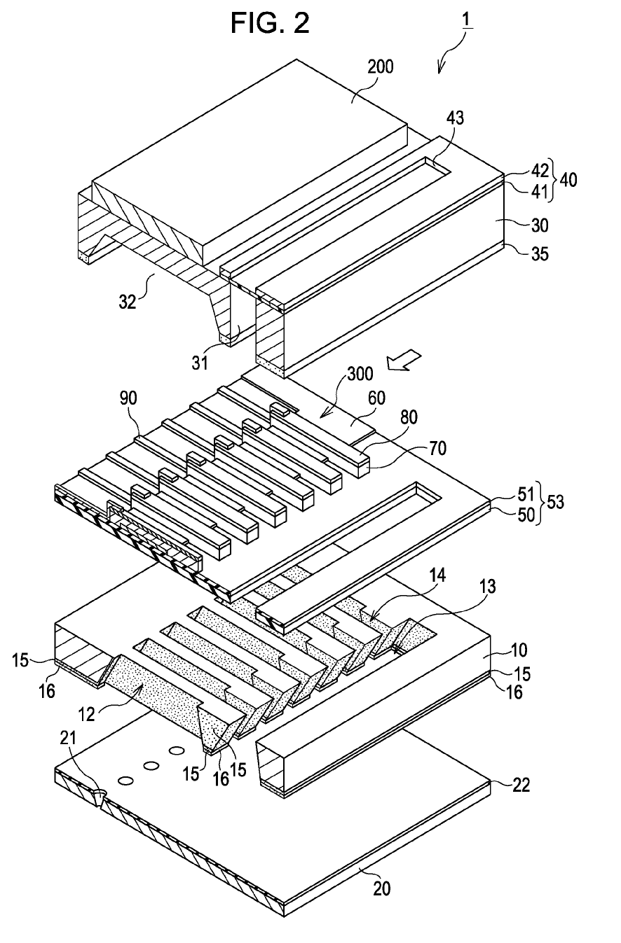

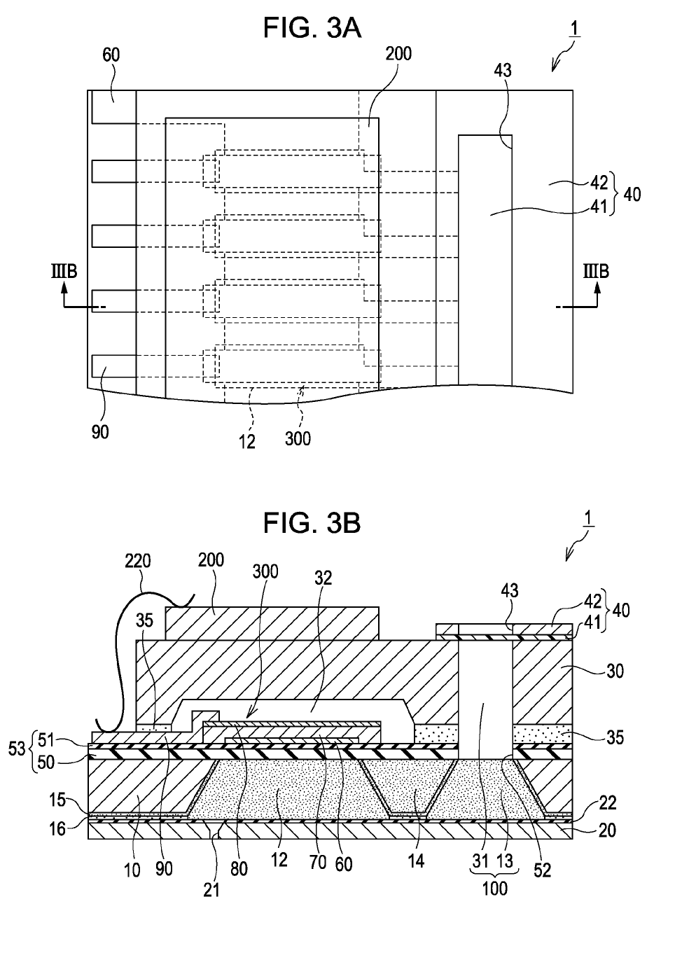

Each of the recording head units 1A and 1B includes an ink jet recording head 1 as a liquid ejecting head at a position facing the recording sheet S. An exploded partial perspective view of the ink jet recording head 1 is shown in FIG. 2. The ink jet recording head 1 substantially has a rectangular parallelepiped shape, and FIG. 2 is an exploded partial perspective view of the ink jet recording head 1 cut along a surface orthogonal to the longitudinal direction (the direction of the empty arrow in the figure) of the ink jet recording head 1. FIG. 3A is a partial plan view of the ink jet recording head 1, and FIG. 3B is a cross-sectional view taken along line IIIB-IIIB in FIG. 3A.

Referring to FIG. 2 and FIGS. 3A and 3B, the ink jet recording head 1 includes a channel-forming substrate 10 serving as a first channel-forming substrate, a nozzle plate 20 serving as a second channel-forming substrate, a joining substrate 30, a compliance substrate 40, and a driving IC 200. The channel-forming substrate 10, the nozzle plate 20, and the joining substrate 30 are stacked so that the channel-forming substrate 10 is disposed between the nozzle plate 20 and the joining substrate 30. The compliance substrate 40 is disposed on the joining substrate 30. The driving IC 200 is disposed on the compliance substrate 40.

The channel-forming substrate 10 is composed of a single-crystal silicon substrate having a (110) crystal plane orientation. A plurality of pressure-generating chambers 12 are provided in the channel-forming substrate 10 in a row. Each of the pressure-generating chambers 12 has a trapezoidal shape in a cross section orthogonal to the longitudinal direction of the ink jet recording head 1. Each of the pressure-generating chambers 12 is disposed so as to extend in the width direction of the ink jet recording head 1.

An ink supply channel 13 is provided at an end in the width direction of the pressure-generating chambers 12 of the channel-forming substrate 10. The ink supply channel 13 communicates with each of the pressure-generating chambers 12, with communication sections 14 provided for the respective pressure-generating chambers 12. The communication sections 14 are provided so as to have a width smaller than the width of the pressure-generating chambers 12, and maintain a channel resistance of ink flowing from the communication sections 14 to the pressure-generating chambers 12 to be constant. The pressure-generating chambers 12, the communication sections 14, the ink supply channel 13, and the like are obtained by anisotropically etching (wet etching) the single-crystal silicon substrate using a mask. More specifically, the pressure-generating chambers 12, the communication sections 14, and the ink supply channel 13 are formed at the same time by etching the single-crystal silicon substrate using, for example, an etchant such as an aqueous potassium hydroxide (KOH) solution.

A first protective film 15 is provided on a surface of the channel-forming substrate 10, the surface facing the nozzle plate 20, and side faces of the pressure-generating chambers 12, the ink supply channel 13, and the communication sections 14. The first protective film 15 is preferably formed at a low temperature. For example, a tantalum oxide film formed by chemical vapor deposition (CVD) is used as the first protective film 15. Alternatively, a zirconium (Zr) film, a silicon nitride film, or the like may be used as the first protective film 15 instead of the tantalum oxide film.

Nozzle openings 21 are provided in the nozzle plate 20. Each of the nozzle openings 21 communicates with substantially an end of the corresponding pressure-generating chamber 12, the end being located opposite the ink supply channel 13. The nozzle plate 20 has a thickness in the range of, for example, 0.01 to 1 mm and is composed of a glass-ceramic material, a single-crystal silicon substrate, a stainless steel, or the like having a coefficient of linear expansion, for example, in the range of 2.5 to 4.5 (×10⁻⁶/° C.) at 300° C. or lower. A second protective film 22 is provided on a surface of the nozzle plate 20, the surface facing the channel-forming substrate 10.

The channel-forming substrate 10 is bonded to the nozzle plate 20 with the first protective film 15 and the second protective film 22 therebetween using an adhesive 16. For example, an epoxy adhesive can be used as the adhesive 16. The second protective film 22 is configured so that a contact angle θ2 of the surface of the second protective film 22 to the adhesive 16 is smaller than a contact angle θ1 of the surface of the first protective film 15 to the adhesive 16. For example, in the case where the adhesive 16 is an epoxy adhesive, when a tantalum oxide film is used as the first protective film 15, a silicon dioxide film can be used as the second protective film 22. When the nozzle plate 20 is composed of a single-crystal silicon substrate, a silicon dioxide film can be formed as the second protective film 22 on the surface of the nozzle plate 20 by thermal oxidation.

An elastic film 50 is provided on a surface of the channel-forming substrate 10, the surface being opposite the surface on which the nozzle plate 20 is bonded. The elastic film 50 is composed of a silicon dioxide film formed by thermal oxidation. In addition, an insulating film 51 composed of an oxide film is provided on the elastic film 50 of the channel-forming substrate 10. Specifically, for example, a zirconium layer is formed on the elastic film 50 by a sputtering method or the like, and the zirconium layer is then thermally oxidized in a diffusion furnace at a temperature, for example, in the range of 500° C. to 1,200° C. Thus, the insulating film 51 composed of zirconium oxide is formed. Furthermore, a lower electrode 60, a piezoelectric layer 70 having a perovskite structure, and an upper electrode 80 are provided on the insulating film 51 to constitute a piezoelectric element 300 serving as a pressure-generating element. Herein, the term “piezoelectric element 300” refers to a portion including the lower electrode 60, the piezoelectric layer 70, and the upper electrode 80.

The piezoelectric elements 300 are specifically formed as follows. The lower electrode 60 is formed by stacking a metal such as platinum or a metal oxide such as strontium ruthenate on the insulating film 51. For example, first, a layer containing, for example, iridium is formed, a layer containing, for example, platinum is subsequently formed, and a layer containing, for example, iridium is further formed. Each of the layers constituting the lower electrode 60 is formed by depositing iridium or platinum on a surface of the insulating film 51 by a sputtering method or the like. Subsequently, the lower electrode 60 is patterned so as to have a predetermined shape.

Next, the piezoelectric layer 70 composed of lead zirconate titanate (PZT) or the like and the upper electrode 80 composed of a metal such as gold (Au) or iridium (Ir) are formed. Subsequently, the piezoelectric layer 70 and the upper electrode 80 are patterned. Examples of the material of the piezoelectric layer 70 constituting the piezoelectric elements 300 include ferroelectric-piezoelectric materials such as lead zirconate titanate (PZT) and relaxor ferroelectric materials in which a metal such as niobium, nickel, magnesium, bismuth, or yttrium is added to the ferroelectric-piezoelectric materials. The composition of the material may be appropriately selected in view of characteristics, the application, and the like of the piezoelectric elements 300. Specific examples of the material include PbTiO₃ (PT), PbZrO₃ (PZ), Pb(ZrₓTi₁₋ₓ)O₃ (PZT), Pb(Mg_{1/3}Nb_{2/3})O₃—PbTiO₃ (PMN-PT), Pb(Zn_{1/3}Nb_{2/3})O₃—PbTiO₃ (PZN-PT), Pb(Ni_{1/3}Nb_{2/3})O₃—PbTiO₃ (PNN-PT), Pb(In_{1/2}Nb_{1/2})O₃—PbTiO₃ (PIN-PT), Pb(Sc_{1/2}Ta_{1/2})O₃—PbTiO₃ (PST-PT), Pb(Sc_{1/2}Nb_{1/2})O₃—PbTiO₃ (PSN-PT), and BiScO₃—PbTiO₃ (BS-PT), and BiYbO₃—PbTiO₃ (BY-PT).

The method of forming the piezoelectric layer 70 is not particularly limited. For example, in this embodiment, the piezoelectric layer 70 can be formed by a sol-gel method. Specifically, a sol prepared by dissolving and dispersing a metal organic compound in a catalyst is applied and then dried to form a gel. Furthermore, the resulting gel is then fired at a high temperature to form the piezoelectric layer 70 composed of a metal oxide.

In general, one of the electrodes of the piezoelectric elements 300 is used as a common electrode, and the other electrode and the piezoelectric layer 70 are patterned for each of the pressure-generating chambers 12. Herein, a portion which is constituted by the patterned electrode and piezoelectric layer 70 and in which piezoelectric strain is generated by applying a voltage between the electrodes is referred to as “piezoelectric active portion”. In this embodiment, the lower electrode 60 is used as a common electrode of the piezoelectric elements 300, and the upper electrode 80 is used as an individual electrode of each of the piezoelectric elements 300. However, no problems occur when the upper electrode 80 is used as the common electrode and the lower electrode 60 is used as the individual electrode of each of the piezoelectric elements 300 in accordance with the structure of a driving circuit or wiring. In either case, the piezoelectric active portion is provided for each of the pressure-generating chambers 12. Herein, a piezoelectric element 300, and the elastic film 50 and the insulating film 51 (these two films being referred to as “diaphragm 53” as a whole), in which a displacement is generated by driving the piezoelectric element 300, are referred to as “actuator” as a whole. Here, the insulating film 51 need not be formed as a part of the diaphragm 53.

In FIG. 2 and FIGS. 3A and 3B, lead electrodes 90 for upper electrodes are connected to the upper electrodes 80 constituting the piezoelectric elements 300 described above. The joining substrate 30 is bonded, with an adhesive 35, on the channel-forming substrate 10 having the piezoelectric elements 300 thereon. The driving IC 200 for driving the piezoelectric elements 300 is mounted on the joining substrate 30. The joining substrate 30 has a piezoelectric element-holding section 32 in an area facing the piezoelectric elements 300. The piezoelectric element-holding section 32 provides and seals a space in which the movement of the piezoelectric elements 300 is not substantially disturbed. The piezoelectric element-holding section 32 is provided so as to correspond to the row of the pressure-generating chambers 12.

In this embodiment, the piezoelectric element-holding section 32 is integrally provided in the area corresponding to the row of the pressure-generating chambers 12. Alternatively, the piezoelectric element-holding section 32 may be independently provided for each of the piezoelectric elements 300. Examples of the material of the joining substrate 30 include glass, ceramic materials, metals, and resins. More preferably, the joining substrate 30 is composed of a material having a coefficient of thermal expansion substantially the same as that of the channel-forming substrate 10. In this embodiment, the joining substrate 30 is composed of a single-crystal silicon substrate, which is the same material as the channel-forming substrate 10.

A reservoir section 31 is provided in the joining substrate 30. The reservoir section 31 is disposed in an area corresponding to the ink supply channel 13 of the channel-forming substrate 10. This reservoir section 31 is provided in the thickness direction of the joining substrate 30 along the row of the pressure-generating chambers 12. The reservoir section 31 communicates with the ink supply channel 13 of the channel-forming substrate 10 through a through-hole 52 to constitute a reservoir 100 functioning as an ink chamber common to the pressure-generating chambers 12.

Furthermore, a wiring pattern to which external wiring (not shown) is connected and driving signals are supplied is provided on the joining substrate 30. The driving IC 200 which is a semiconductor integrated circuit (IC) for driving each of the piezoelectric elements 300 is mounted on the wiring pattern.

The driving signals include, for example, driving signals, such as a driving power-supply signal, for driving the driving IC and control signals such as a serial signal (SI). The wiring pattern includes a plurality of wirings to which the signals are supplied.

The lower electrode 60 is provided in an area facing the pressure-generating chambers 12 in the longitudinal direction of the pressure-generating chambers 12, and is continuously provided in an area corresponding to the plurality of pressure-generating chambers 12. The lower electrode 60 extends to the outside of the row of the pressure-generating chambers 12.

Each of the lead electrodes 90 for upper electrodes is connected near an end of the corresponding upper electrode 80. The driving IC 200 is electrically connected to each of the lead electrodes 90 for upper electrodes extending from the piezoelectric elements 300 via connection wiring 220 composed of electrically conductive wires such as bonding wires. Similarly, the driving IC 200 is electrically connected to the lower electrode 60 via connection wiring (not shown).

Furthermore, the compliance substrate 40 composed of a sealing film 41 and a fixing plate 42 is bonded on the joining substrate 30. The sealing film 41 is composed of a material (e.g., a polyphenylene sulfide (PPS) film having a thickness of 6 μm) having flexibility and a low rigidity. This sealing film 41 seals one surface of the reservoir section 31. The fixing plate 42 is composed of a hard material such as a metal (e.g., a stainless steel (SUS) plate having a thickness of 30 μm). An area of the fixing plate 42 facing the reservoir 100 forms an opening 43 in which the fixing plate 42 is completely removed in the thickness direction. Accordingly, only the flexible sealing film 41 constitutes the surface of the reservoir 100.

As for a method of producing the ink jet recording head 1, for example, a plurality of ink jet recording heads 1 are formed in the form of a wafer, and the wafer is then cut to separate the ink jet recording heads 1.

This embodiment can achieve the following advantages.

(1) The first protective film 15 is provided on the inner surfaces of the pressure-generating chambers 12, the ink supply channel 13, and the communication sections 14, and the second protective film 22 is provided on a surface of the nozzle plate 20, the surface facing the channel-forming substrate 10. Accordingly, corrosion due to ink can be prevented, and thus an ink jet recording head 1 having stable ink-ejecting characteristics can be obtained. Furthermore, when the channel-forming substrate 10 is bonded to the nozzle plate 20 with the adhesive 16, a contact angle θ1 of the first protective film 15 to the adhesive 16 before curing is larger than a contact angle θ2 of the second protective film 22 to the adhesive 16 before curing. Accordingly, the adhesive 16 before curing flows along the second protective film 22 with which the adhesive 16 has good affinity, and thus flow of the adhesive 16 before curing to the pressure-generating chambers 12, the ink supply channel 13, and the communication sections 14 can be suppressed. As a result, adhesion of the adhesive 16 to the diaphragm 53 of the pressure-generating chambers 12 can be suppressed. Thus, an ink jet recording head 1 and an ink jet recording apparatus 1000 in which a degradation and variations in the displacement characteristics of the diaphragm 53 are suppressed can be obtained.

(2) A contact angle θ1 of an epoxy adhesive to tantalum oxide is larger than a contact angle θ2 of the epoxy adhesive to silicon oxide, and tantalum oxide and silicon oxide have high corrosion resistance against ink. In addition, since a film of tantalum oxide can be deposited at low temperatures, an effect of heat on the diaphragm 53 and the like which have been formed on the channel-forming substrate 10 can be reduced. Accordingly, the ink-ejecting characteristics can be further stabilized, and thus an ink jet recording head 1 and an ink jet recording apparatus 1000 in which a degradation and variations in the displacement characteristics of the diaphragm 53 are suppressed can be obtained.

(3) Both the channel-forming substrate 10 and the nozzle plate 20 are composed of silicon, and thus generation of distortion and warpage due to a difference in thermal expansion can be suppressed. Furthermore, tantalum oxide and silicon oxide are a combination in which adhesiveness to silicon can be ensured.

### Second Embodiment

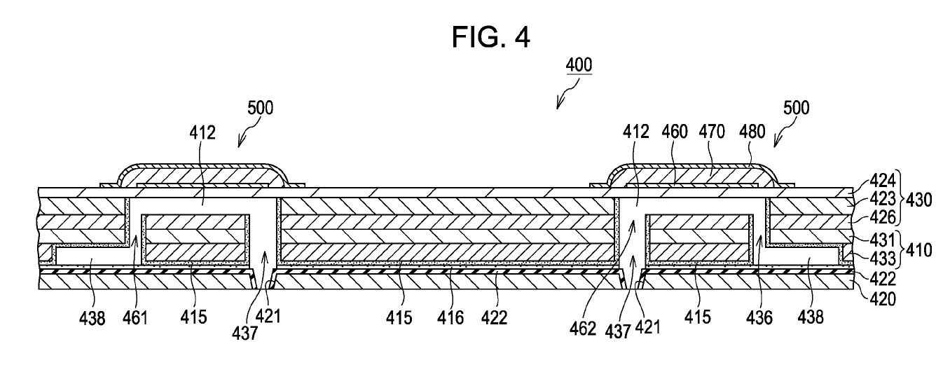

FIG. 4 is a partial cross-sectional view of a head unit 400 as a liquid ejecting head. The head unit 400 is also used in an ink jet recording apparatus as a liquid ejecting apparatus. The head unit 400 is constituted by integrating a channel unit 410, a nozzle plate 420, and an actuator 430 in a stacked manner. FIG. 4 is a partial cross-sectional view of a portion including the actuator 430.

The actuator 430 includes two pressure-generating chambers 412 in a head-scanning direction. Each of the pressure-generating chambers 412 ejects a liquid therein through a nozzle opening 421 by a change in pressure. The actuator 430 includes two piezoelectric vibrators 500 in the head-scanning direction. The piezoelectric vibrators 500 are provided so as to correspond to the pressure-generating chambers 412. The shape of each of the piezoelectric vibrators 500 is changed by a driving signal supplied, and the piezoelectric vibrators 500 cause a change in pressure of the liquid in the pressure-generating chambers 412. Furthermore, the pressure-generating chambers 412 and the piezoelectric vibrators 500 are provided so as to correspond to nozzles arranged in a direction of a nozzle row. Accordingly, the actuator 430 has a long shape in the direction of the nozzle row. A single actuator 430 ejects a liquid from a single nozzle row.

The actuator 430 is constituted by stacking a pressure chamber plate 423, a vibrator plate 424, and a communication opening plate 426. The pressure chamber plate 423 functions as a channel-forming substrate and includes openings constituting the pressure-generating chambers 412. A plurality of piezoelectric vibrators 500 are mounted on the vibrator plate 424 in a lateral direction, and the vibrator plate 424 defines a part of each of the pressure-generating chambers 412. The communication opening plate 426 also functions as a channel-forming substrate and includes openings 462 functioning as a supply-side communication opening 461 and a nozzle communication opening 437. Each of the pressure chamber plate 423, the vibrator plate 424, and the communication opening plate 426 are composed of a metal, and these plates are bonded to each other with an adhesive.

The plurality of pressure-generating chambers 412 form long hollow portions extending in a direction orthogonal to the nozzle row and provided so as to correspond to the nozzle openings 421. An end of each of the pressure-generating chambers 412 communicates with a reservoir 438 through the supply-side communication opening 461 or an ink supply port 436. Another end of each of the pressure-generating chambers 412 opposite the supply-side communication opening 461 or the ink supply port 436 communicates with the nozzle opening 421 through the nozzle communication opening 437. A part of each of the pressure-generating chambers 412 is defined by the vibrator plate 424.

In this embodiment, each of the piezoelectric vibrators 500 is a flexural-mode piezoelectric vibrator that performs flexural vibration in accordance with an electric field applied to the piezoelectric vibrator 500 functioning as a pressure-generating element. Each of the piezoelectric vibrators 500 includes a driving electrode 480, a common electrode 460, and a piezoelectric layer 470. The piezoelectric layer 470 is disposed between the driving electrode 480 and the common electrode 460. Each of the piezoelectric vibrators 500 is provided on a surface of the vibrator plate 424, the surface being opposite the pressure-generating chambers 412, so as to cover the corresponding pressure-generating chamber 412. Specifically, the piezoelectric vibrators 500 are arranged in the direction of the nozzle row so as to correspond to the pressure-generating chambers 412. In this embodiment, piezoelectric vibrators disposed at ends of the row of the piezoelectric vibrators are not involved in the ejection of ink droplets. That is, the piezoelectric vibrators disposed at the ends are dummy vibrators to which no driving signal is supplied or which does not drive.

The channel unit 410 includes a plurality of channel-forming substrates, namely, a supply port plate 431 and a reservoir plate 433. The supply port plate 431 functions as a channel-forming substrate and includes openings for the supply port plate that constitute a part of each of the ink supply port 436 and the nozzle communication openings 437, which function as orifices. The reservoir plate 433 also functions as a channel-forming substrate and includes the reservoirs 438 (common liquid chambers) to which ink is supplied and openings for the reservoir plate that constitute a part of each of the nozzle communication opening 437.

The nozzle plate 420 is disposed on one surface of the reservoir plate 433, and the supply port plate 431 is disposed on the other surface of the reservoir plate 433. These plates are bonded to each other with an adhesive (not shown). The channel unit 410 forms the nozzle communication openings 437 which are ink channels each extending from the reservoir 438 to the nozzle opening 421.

A first protective film 415 is provided on the inner surfaces of the nozzle communication openings 437, the inner surfaces of the reservoirs 438, and a surface facing the nozzle plate 420. In addition, a second protective film 422 is provided on a surface of the nozzle plate 420, the surface facing the channel unit 410. The first protective film 415 and the second protective film 422 can be formed using the same material and by the same method as those of the first protective film 15 and the second protective film 22 in the first embodiment. In this embodiment, the second protective film 422 is provided also on the inner surfaces of the nozzle openings 421. The channel unit 410 is bonded to the nozzle plate 420 with an adhesive 416.

This embodiment can achieve the following advantage.

(4) The advantages described above can be achieved also in the head unit 400 including, as a plurality of channel-forming substrates, the pressure chamber plate 423, the communication opening plate 426, the supply port plate 431, and the reservoir plate 433.

In addition to the embodiments described above, various modifications can be made. For example, in the above embodiments, the first protective film 15 and the first protective film 415 may be provided on the diaphragm 53 and the vibrator plate 424, respectively.

In the above embodiment, the piezoelectric elements 300 are provided in the piezoelectric element-holding section 32 of the joining substrate 30, but the structure of the ink jet recording head is not limited thereto. Alternatively, the piezoelectric elements 300 may be exposed.

In the above embodiments, an ink jet recording head has been described as an example of a liquid ejecting head. However, the basic structure of the liquid ejecting head is not limited to the structures described above. The structure is widely used in overall liquid ejecting heads and can be applied to liquid ejecting heads that eject a liquid other than ink. Examples of the other liquid ejecting heads include recording heads used in an image-recording apparatus such as a printer, coloring-material-ejecting heads used in producing a color filter of a liquid crystal display or the like, electrode-material-ejecting heads used for forming an electrode of an organic EL display, a field emission display (FED), or the like, and living-organic-material-ejecting heads used for producing a biochip.

What is claimed is:

1. A liquid ejecting head that ejects a liquid from a nozzle opening, comprising:
a first channel-forming substrate including a pressure-generating chamber a part of which is constituted by a diaphragm;
a second channel-forming substrate disposed on a surface opposite the diaphragm of the first channel-forming substrate;
an actuator that includes the diaphragm and that applies a pressure to the pressure-generating chamber to eject the liquid from the nozzle opening;
a first protective film having liquid resistance and disposed on an inner surface of the pressure-generating chamber; and
a second protective film having liquid resistance and disposed on at least a surface of the second channel-forming substrate, the surface facing the first channel-forming substrate,
wherein the first channel-forming substrate is bonded to the second channel-forming substrate with an adhesive provided between the first protective film and the second protective film, and
a contact angle θ1 of a surface of the first protective film to the adhesive before curing is larger than a contact angle θ2 of a surface of the second protective film to the adhesive before curing.

2. The liquid ejecting head according to claim 1,
wherein the adhesive is an epoxy adhesive,
the first protective film is composed of tantalum oxide, and
the second protective film is composed of silicon oxide.

3. The liquid ejecting head according to claim 1, wherein the first channel-forming substrate and the second channel-forming substrate are composed of silicon.

4. A liquid ejecting apparatus comprising:
the liquid ejecting head according to claim 1.
